(19) United States
(12) Patent Application Publication
(10) Pub. No.: US 2026/0144342 A1
(43) Pub. Date: May 28, 2026

(54) METHOD FOR DECORATING HOROLOGY COMPONENTS

(71) Applicant: The Swatch Group Research and Development Ltd., Marin (CH)

(72) Inventors: Vladislav SPASSOV, Praz (CH); Loïc CURCHOD, Lausanne (CH); Mina MORADI, Olten (CH); Simon SPRINGER, Berne (CH)

(73) Assignee: The Swatch Group Research and Development Ltd., Marin (CH)

(21) Appl. No.: 19/380,266

(22) Filed: Nov. 5, 2025

(30) Foreign Application Priority Data
Nov. 26, 2024 (EP) 24215563.8

(51) Int. Cl. A44C 27/00; C09C 1/62; C09C 1/64; C09C 3/06

(52) U.S. Cl. CPC A44C 27/005; C09C 1/622; C09C 1/64; C09C 3/063; B22F 2998/10; C01P 2004/24; C09C 2200/304; C09C 2200/307

(57) ABSTRACT

A method for decorating a horology component with white plating. The method includes preparing the horology component, depositing a metallic adhesion layer over the entire horology component in a deposition chamber via physical vapour deposition, depositing an aluminium diffusion layer over the entire component under a flow of reagent gas such that the aluminium layer is deposited in the form of a faceted crystalline structure via physical vapour deposition to a desired thickness, depositing a hard layer on this aluminium layer which protects it mechanically but preserves its faceted texture via physical vapour deposition, depositing a thin, highly reflective metallic layer on this hard layer via physical vapour deposition, and lastly, depositing a transparent layer for protection and/or increased reflection on this reflective layer using the ALD method.

### CROSS-REFERENCE TO RELATED APPLICATIONS

This application claims priority to European Patent Application No. 24215563.8, filed on November 26, 2024, the entire contents of which are incorporated herein by reference.

### TECHNICAL FIELD OF THE INVENTION

The invention relates to a plating with a white surface obtained by superimposing layers deposited by PVD and ALD. The invention also relates to horology components with such a white surface.

### TECHNOLOGICAL BACKGROUND

The horology industry is continually seeking new solutions in terms of colours and appearance. White horology parts, such as dials, are often made using mother-of-pearl or by applying enamel.

The surface of precious metals such as silver, platinum, palladium, and rhodium gives them a brilliant appearance. Such an appearance can also be achieved by electroplating these metals. However, they reflect light specularly, giving the surface of the part a brilliant metallic sheen. By judiciously setting the parameters of the electroplating method, the specular reflection of this plating can be lowered, giving it a matt white appearance.

Physical vapour deposition (PVD) techniques, such as cathodic sputtering, can be used to deposit thin plating with predetermined properties on substrates of various types and with complex (three-dimensional) geometries.

Several other natural substances are white in colour. Examples include pigments consisting of microparticles of mineral substances such as titanium oxide or aluminium oxide. These particles reflect light diffusely. These pigments are deposited in the form of paints, lacquers or enamels on the surface of the parts.

However, pigment-based white plating does not enable sufficient, satisfactory decorative quality to be achieved. Indeed, they do not enable the surface finish of the substrate to be preserved, nor do they accurately preserve the details of the decorations. Moreover, electroplating used in the prior art has a matt appearance and is relatively brittle.

There is therefore a need for a white plating that preserves the surface finish of the substrate and the details of the decorations.

### SUMMARY OF THE INVENTION

The invention aims in particular to remedy the various drawbacks of the methods used in the prior art.

More specifically, one purpose of the invention is to provide a method for manufacturing a “porcelain” white plating that preserves the surface finish of the polished, matt, sunburst or any other decorative substrate, as well as a horology component with a surface plated with a thin white layer obtained by this method.

To this end, the invention relates to a method for decorating a horology component with a white plating, comprising the following steps:

preparing the horology component and installing said component in a deposition chamber;

depositing a metallic adhesion layer over the entire horology component via physical vapour deposition;

depositing an aluminium diffusion layer over the entire component, under a flow of a reagent gas, so that the deposited layer contains between 0.5 at% and 10 at% of this gas, such that the aluminium layer crystallises in the form of a faceted crystal structure, via physical vapour deposition;

depositing a hard layer on the diffusion layer to increase the resistance of the diffusion layer to scratches and mechanical damage, while preserving the texture of the diffusion layer;

depositing a layer of pure metal to increase the reflectivity of the previously deposited layers;

depositing a transparent layer using the ALD method or another vacuum deposition method to enhance the white appearance through interference effects and to chemically protect the layers deposited in the previous steps;

alternatively, depositing a transparent protective layer using the ALD method or another vacuum deposition method.

According to other advantageous variants of the invention:

the adhesion layer is a metallic layer or a layer of a metallic alloy that can be chosen among: aluminium, titanium, titanium aluminide, nickel or chromium.

the adhesion layer has a minimum thickness of 5 nm;

the diffusion layer has a thickness comprised between 300 nm and 6,000 nm, preferably between 1,000 nm and 2,000 nm, preferably of 1,500 nm;

the hard layer has a thickness comprised between 100 nm and 3,000 nm, preferably between 400 nm and 2,000 nm, preferably of 1,000 nm;

the hard layer is made of a material chosen among DLC, nitrides or carbonitrides, oxynitrides or titanium oxide, titanium-aluminium oxide, silicon oxide, aluminium oxide, nickel oxide or chromium oxide;

the final layer of pure metal has a thickness comprised between 20 nm and 400 nm, preferably of 200 nm;

the pure metal layer is made of a highly reflective metal chosen among aluminium, silver, rhodium or chromium;

the transparent layer comprises a coating of transparent dielectric layers;

the transparent dielectric layers have a refractive index of between 1.38 and 2.6 at a wavelength of 633 nm and a thickness of between 5 nm and 500 nm;

the transparent protective layer has a thickness comprised between 0.5 nm and 20 nm, preferably of 2 nm;

the transparent protective layer can be chosen among the following materials: titanium dioxide, aluminium oxide, silicon dioxide, silicon nitride or other transparent materials resistant to typical environments in the product's service life;

preparing the horology component prior to depositing the aforementioned layers comprises a washing step;

the horology component has the desired decorations and/or desired surface finish;

the reagent gas used when depositing the transmission layer is oxygen or nitrogen or a mixture of both.

The invention also relates to a horology component with a white plating obtained using the method according to the invention.

### BRIEF DESCRIPTION OF THE FIGURES

Other features and advantages of the invention will become apparent from the following detailed description, given by way of non-limiting example, with reference to the attached drawings in which:

FIG. 1 schematically shows a substrate with a white plating obtained according to the method of the invention;

FIG. 2 schematically shows the steps in the method according to the invention.

### DETAILED DESCRIPTION OF THE INVENTION

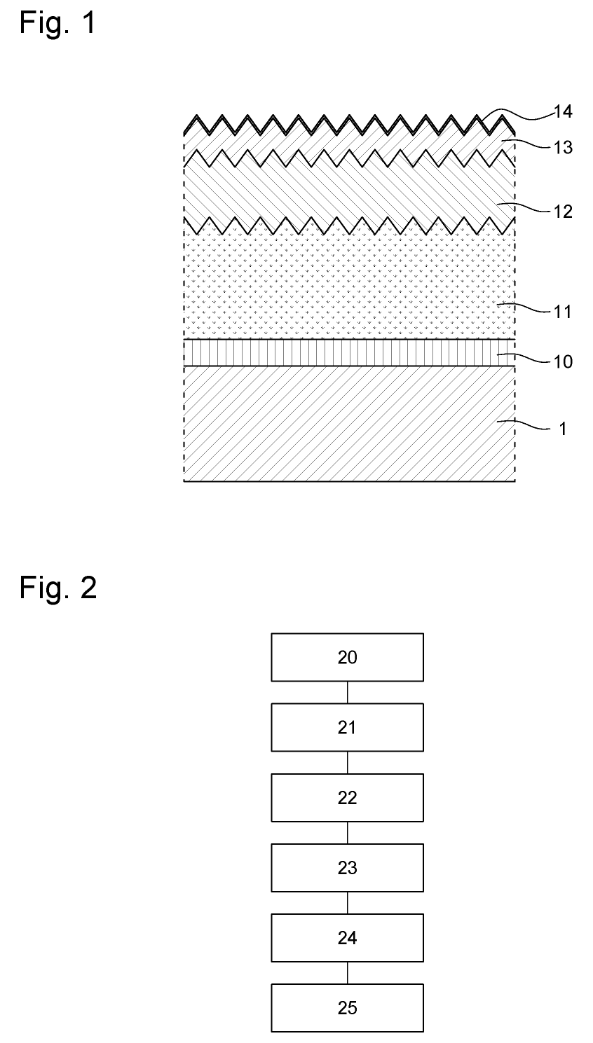

FIG. 1 shows a schematic representation of the coating of layers obtained according to the method of the invention.

According to one aspect of the invention, the deposition of the plating imparting a white colour to the surface of the decorative part is carried out by a series of PVD and ALD deposits.

Preferably, a chamber equipped with a magnetron-type sputtering system is used for the purposes of the invention. Said sputtering system comprises at least one aluminium sputtering target and gas injection lines for creating a controlled reagent or inert atmosphere inside the chamber. The function of this sputtering device is described in scientific and technical literature, is known to the person skilled in the art, and will only be broadly outlined herein.

The method according to the invention comprises a first step 20 in which the substrate, in this case the horology component, is cleaned in place in the deposition system by plasma polarisation of the substrate holder or by any other method known to the person skilled in the art.

The method comprises a second step 21 in which a first layer 10, known as an adhesion layer, is deposited on the substrate 1. The adhesion layer 10 can consist, for example, of aluminium deposited by sputtering from an aluminium source in a neutral atmosphere, that is, without the addition of reagent gas. The adhesion layer can also be made up of titanium, titanium aluminide or chromium and typically has a thickness of between 30 nm and 100 nm, preferably of 50 nm.

The third step 22 comprises depositing a second layer 11. In this step, a cathode equipped with an aluminium target is used and a reagent gas, such as oxygen, nitrogen or a mixture of both, is introduced into the chamber and kept at a rate that produces an aluminium layer doped with 0.5 at% to 10 at% of reagent gas, referred to as the diffusion layer 11. The diffusion layer 11 has a thickness comprised between 300 nm and 6,000 nm, preferably between 1,000 nm and 2,000 nm, preferably of 1,500 nm.

The purpose of this third step is to influence the deposition of aluminium atoms with the reagent gas to obtain a layer of aluminium oxide (or aluminium nitride in the case of nitrogen, or aluminium oxynitride in the case of a mixture of nitrogen and oxygen) with a faceted crystal structure. Such a layer makes it possible to obtain a diffusing effect of the incident light due to its faceted crystalline structure.

A fourth step 23 comprises depositing a hard layer 12 on the diffusion layer 11, the hard layer 12 being chosen among hard materials known to the person skilled in the art, such as DLC, nitrides or carbonitrides, titanium oxide, titanium-aluminium oxide, silicon oxide, aluminium oxide or chromium oxide.

The function of this hard layer 12 is to protect the aluminium diffusion layer, which is brittle and sensitive to scratches and mechanical damage. The hard layer 12 must also match the texture of the diffusion layer in order to preserve the diffusing appearance of the horology component. The hard layer 12 has a thickness of between 200 nm and 3,000 nm, preferably of between 400 nm and 2,000 nm, preferably of 1,000 nm.

In a fifth step 24, a layer of pure metal 13 is deposited on the hard layer 12. This layer of pure metal 13 is used to mask the colour of the hard layer 12 and to give the horology component a diffusing white appearance. The final layer of pure metal 13 has a thickness comprised between 20 nm and 400 nm, preferably of 200 nm.

The pure metal layer 13 is made of a highly reflective metal chosen among aluminium, silver, rhodium, or chromium.

To further enhance the reflectivity of the horology component and thereby its “white” appearance, a transparent layer 14 referred to as a “booster” layer is deposited in a sixth step 25.

This transparent layer 14 consists of a thin-film dielectric coating of transparent materials with refractive indices and thicknesses chosen such that, as a result of the interference effect, the L* value in the 1976 CIE colour space of the horology component increases relative to the value without the coating, while retaining its hue (a*, b*). For example, the refractive index ranges from 1.38 (like that of MgF₂) to 2.6 (like that of TiO₂) at a wavelength of 633 nm, and the thickness ranges from 5 nm to 500 nm.

This transparent layer 14 also protects the previously deposited layers from becoming corroded by the environments typically encountered over the service life of a watch. If this layer 14 is unnecessary (such as in cases in which the “white” effect is satisfactory without said layer 14), it can be omitted.

Lastly, in a seventh step 26, a sixth transparent protective layer 15 is deposited, preferably using an ALD deposition method. The protective layer 15 is made of one of the following materials: titanium dioxide, aluminium oxide, silicon dioxide, or silicon nitride. This step is necessary if step 25 is omitted or if the coating as of this step does not provide sufficient protection for the layers. The diffusion layer 11 thus covered with a layer of pure metal 13 effectively reflects diffuse white light, imparting a white colour to the treated substrate while preserving the details of its surface finish and decoration.

First exemplary embodiment of the method according to the invention:

the substrate 1 is cleaned in place in the deposition chamber via plasma polarisation of the substrate holder;

an aluminium adhesion layer is deposited using an aluminium target with no addition of reagent gas;

then, without switching off the cathode, oxygen is introduced into the deposition chamber; the oxygen flow is chosen and controlled so that a 1,600 nm layer of aluminium with an oxygen content of between 0.5 at% and 10 at% is deposited with a diffusing crystalline structure;

then, without switching off the cathode, the oxygen flow is increased and kept at a value that allows a hard 1,000 nm layer to be obtained with a composition close to that of Al₂O₃

next, without switching off the cathode, the oxygen flow is stopped completely in order to finish the deposition of the coating with a thin 100 nm film of pure aluminium, with no oxygen doping, which imparts a diffuse white appearance to the coating;

once the desired thickness of the pure aluminium film has been achieved, the PVD deposition method is finished and a transparent “booster” and/or protective layer is deposited using the ALD deposition method.

Second exemplary embodiment of the method according to the invention:

the substrate 1 is cleaned in place in the deposition chamber via plasma polarisation of the substrate holder;

an aluminium adhesion layer is deposited using an aluminium target with no addition of reagent gas;

then, without switching off the cathode, nitrogen is introduced into the deposition chamber; the nitrogen flow is chosen and controlled so that an 800 nm layer of aluminium with a nitrogen content of between 0.5 at% and 10 at% is deposited with a diffusing crystalline structure;

once the desired thickness of the doped nitrogen layer has been achieved, a hard 1,000 nm layer of TiN is deposited on the nitrogen-doped aluminium layer;

a thin 160 nm film of pure aluminium is then deposited to impart a diffuse white appearance to the coating;

once the desired thickness of the pure aluminium film has been achieved, the PVD deposition method is finished and a transparent “booster” is deposited using the ALD deposition method. This coating consists of 30 nm to 90 nm of aluminium oxide and 20 nm to 100 nm of titanium oxide and its function is to further increase the reflectivity of the pure aluminium layer, which further enhances the diffuse white appearance of the coating.

The substrate, or horology component, has a polished, structured or decorated surface, for example an engraved, circular-grain, satin-finished, côtes de Genève, snail-patterned, rose engine turn, sunburst, chased surface, etc. The white decorative plating of the invention is sufficiently thin to allow the decoration to be clearly seen and to reflect the surface finish of the underlying substrate. This results in a decorated white surface with a “porcelain” appearance. The surface finish and topography of the substrate are retained and are fully perceptible/visible once the plating is deposited. Thus, a brilliant substrate with circular graining will retain its brilliant appearance and the circular graining will be visible. Similarly, a matt substrate with côtes de Genève will retain its matt appearance and the côtes de Genève will be clearly visible.

The process described in the invention enables a “porcelain” white plating to be deposited on all types of horology components to produce particularly attractive decorative parts. For example, a white plating can be deposited using the method according to the invention to internal parts and movement components such as dials, hands, appliques, bars, plates, barrels, oscillating weights, etc. In addition, the method according to the invention can also be applied to jewellery.

This makes it possible to obtain a horology component with a porcelain-white appearance while preserving the surface finish and the decorations on the component.

1. A method for decorating a horology component (1) with a white plating, comprising the following steps:
preparing the horology component (1) and installing said component in a deposition chamber;
depositing a metallic adhesion layer (10) over the entire horology component via physical vapour deposition;
depositing an aluminium diffusion layer (11) over the entire component, under a flow of reagent gas, the rate of the reagent gas being controlled so as to obtain an aluminium layer doped with 0.5 at% to 10 at% of reagent gas, such that the aluminium layer crystallises in the form of a faceted crystal structure, via physical vapour deposition;
depositing a hard layer (12) on said diffusion layer (11) to increase the resistance of the diffusion layer (11) to scratches and other mechanical damage, while preserving the texture of the diffusion layer;
depositing a layer of pure metal (13) to increase the reflectivity of the previously deposited layers;
depositing a transparent layer (14) using the ALD method or another vacuum deposition method to enhance the white appearance through interference effects and to chemically protect the layers deposited in the previous steps; and
alternatively, depositing a transparent protective layer (15) using the ALD method or another vacuum deposition method.

2. The decorating method according to claim 1, wherein the adhesion layer (10) is a metallic layer or a layer of a metallic alloy chosen among: aluminium, titanium, titanium aluminide or chromium.

3. The decorating method according to claim 1, wherein the adhesion layer (10) has a thickness comprised between 30 nm and 100 nm.

4. The decorating method according to claim 1, wherein the diffusion layer (11) has a thickness comprised between 300 nm and 6,000 nm.

5. The decorating method according to claim 1, wherein the hard layer (12) has a thickness of between 100 nm and 3,000 nm.

6. The decorating method according to claim 1, wherein the hard layer (12) is made of a material chosen among DLC, nitrides or carbonitrides, oxynitrides or titanium oxide, titanium-aluminium oxide, silicon oxide, aluminium oxide, nickel oxide or chromium oxide.

7. The decorating method according to claim 1, wherein the pure metal layer (13) has a thickness of at least 5 nm.

8. The decorating method according to claim 1, wherein the pure metal layer (13) is made from among metals with high reflectivity such as aluminium, silver, rhodium or chromium.

9. The decorating method according to claim 1, wherein the transparent layer (14) comprises a coating of transparent dielectric layers.

10. The decorating method according to claim 9, wherein the transparent dielectric layers have a refractive index of between 1.38 and 2.6 at a wavelength of 633 nm and a thickness of between 5 nm and 500 nm.

11. The decorating method according to claim 1, wherein the protective layer (14) has a thickness comprised between 0.5 nm and 20 nm, preferably of 2 nm.

12. The decorating method according to claim 1, wherein the protective layer (14) is chosen among the following materials: titanium dioxide, aluminium oxide, silicon dioxide, silicon nitride.

13. The decorating method according to claim 1, wherein the reagent gas used for the diffusion layer (11) is oxygen or nitrogen or a mixture thereof.

14. A horology component with a white surface obtained by the method according to claim 1.
